(19) United States
(12) Patent Application Publication
(10) Pub. No.: US 2006/0122885 A1
(43) Pub. Date: Jun. 8, 2006

(54) Promotion method and system

(76) Inventors: Michihiro Ota, Tokyo (JP); Hiroaki Yoshida, Tokyo (JP); Hiroaki Shinada, Tokyo (JP)

Correspondence Address: Welsh & Katz, Ltd.;Daniel M. Gurfinkel, 22nd Floor, 120 South Riverside Plaza, Chicago, IL, 60606, US

(21) Appl. No.: 11/336,051

(22) Filed: Jan. 20, 2006

Related U.S. Application Data
(63) Continuation of application No. 10/044,696, filed on Nov. 1, 2001.

(30) Foreign Application Priority Data
Nov. 6, 2000 (JP) 337759/2000

(51) Int. Cl. G06Q 30/00

(52) U.S. Cl. 705/14

(57) ABSTRACT

A promotion system which can manage a promotion system depending on various conditions and independently configure a plurality of promotion systems for individual distributors. A sub-code comprised of a distributor, date information, price information, an area code, etc. is added to point information.

### BACKGROUND OF THE INVENTION

1. Field of the Invention

The present invention relates to a promotion method and a system for sales promotion of commodities by issuing points when such commodities are sold.

2. Description of the Related Art

For conventional promotion or the like of a particular commodity, a point is issued every time the pertinent commodity is purchased, and a purchaser of the commodity collects the points and redeems the points for a free gift or the like.

Such points are issued by various ways such as stamping or magnetically recording on a card owned by each purchaser, or affixing a seal or the like onto each commodity so that a purchaser collects such seals.

But, issuing the points in a form of affixing onto commodities is very troublesome for both sellers and purchasers in handling them, and a form which adds points to the card owned by each purchaser is hard to issue points by an automatic vending machine, and it is also hard to provide for nation-wide promotion sponsored by the manufacturer of the commodities.

And, all of the above types require the sponsor of the promotion lots of time and trouble to recover the points and totaling them.

To remedy such disadvantages, the inventor have proposed in Japanese Patent Application No. 11-280034 and Japanese Patent Application No. 2000-210217 a point system by which point information having points encrypted is shown to a commodity purchaser when a commodity is sold, the purchaser sends the shown point information to a center unit by a communication device such as a portable telephone or a personal computer, the center unit deciphers the point information and adds points corresponding to the deciphered point information to the points stored and managed in association with the user, and a promotion system by which a seller provides the purchaser with the service according to the points stored and managed by the center unit corresponding to the user using the point system.

But, the aforesaid promotion system cannot perform a sales promotion of commodities according to each distributor.

And, the sales promotion of commodities cannot be performed depending on various conditions such as kinds of sold commodities and a date and time of sales.

### SUMMARY OF THE INVENTION

Accordingly, it is an object of the present invention to provide a promotion method and a system which can perform a sales promotion of commodities according to distributors of commodities and various conditions such as kinds of sold commodities and a date and time of sales.

The promotion method according to the present invention is a promotion method by which point information related to predetermined points is shown to a user when a commodity is sold, the user sends the shown point information together with identification information of the user to a center unit, and the center unit stores and manages points corresponding to the sent point information in connection with the user and provides a predetermined service corresponding to the managed points to the user, wherein system information about a distributor of the commodity is added to the point information, and the center unit separately manages the service provided to the user according to the system information added to the received point information in correspondence with the distributor of the commodity.

Here, the system information is added to the point information when the commodity is sold.

And, the point information is sent to the center unit through a unique system terminal disposed at the distributor of the commodity, and the system information is added to the point information by the system terminal.

The point information includes at least one of a commodity code unique to the commodity, date information when the commodity is sold, price information of the commodity and an area code related to a place where a machine having sold the commodity is installed; and the center unit collectively changes the service to be provided to the user according to at least one of a kind of commodity, a date when the commodity is sold, a price of the commodity and a place where the machine having sold the commodity is installed.

The commodity is sold by an automatic vending machine, and the commodity code is added to the point information in correspondence with the number of a column in which the commodity is stored.

The commodity code is added to the point information in correspondence with a serial number indicated on the commodity.

The commodity code is added to the point information according to information of a bar code related to and indicated on the commodity.

The promotion system according to the present invention is a promotion system by which point information related to predetermined points is shown to a user when a commodity is sold, the user sends the shown point information together with identification information of the user to a center unit, and the center unit stores and manages points corresponding to the sent point information in connection with the user and provides a predetermined service corresponding to the managed points to the user, wherein the promotion system comprises point information issuing means for issuing point information to which system information about a distributor of the commodity is added when the commodity is sold, and system-specific management means which is mounted on the center unit and separately manages in association with the distributor of the commodity the service provided to the user according to the system information added to the point information.

Here, the point information includes at least one of a commodity code unique to the commodity, date information when the commodity is sold, price information of the commodity and an area code related to a place where a machine having sold the commodity is installed; and the center unit collectively changes the service to be provided to the user according to at least one of a kind of commodity, a date when the commodity is sold, a price of the commodity and a place where the machine having sold the commodity is installed.

The promotion system according to the present invention is a promotion system by which point information related to predetermined points is shown to a user when a commodity is sold, the user sends the shown point information together with identification information of the user to a center unit, and the center unit stores and manages points corresponding to the sent point information in connection with the user and provides a predetermined service corresponding to the managed points to the user, wherein the promotion system comprises point information issuing means for issuing the point information when the commodity is sold; a system terminal which is disposed in association with the distributor of the commodity and sends system information about the distributor of the commodity added to the point information to the center unit; and system-specific management means which are mounted on the center unit and separately manage the service provided to the user according to the system information added to the point information in association with the promotion system corresponding to the distributor of the commodity.

And, the point information includes at least one of a commodity code unique to the commodity, date information when the commodity is sold, price information of the commodity and an area code related to a place where a machine having sold the commodity is installed; and the center unit collectively changes the service to be provided to the user according to at least one of a kind of the commodity, a date when the commodity is sold, a price of commodity and a place where the machine having sold the commodity is installed.

According to the present invention, various kinds of information such as a promotion code unique to a promotion system configured on a promotion system, date information related to a date and time when the commodity is sold, price information related to a price of the commodity, etc. are added to the point information, and the data center manages the promotion system configured on the promotion system according to any of various kinds of information or a combination of such various kinds of information, so that a plurality of separate promotion systems can be configured on the same promotion system and detailed marketing information of the subject commodity can be obtained.

### BRIEF DESCRIPTION OF THE DRAWINGS

FIG. 1 is a system configuration diagram showing an example configuration of the promotion system according to the present invention;

FIG. 2 is a diagram illustrating point information according to the promotion system shown in FIG. 1;

FIG. 3 is a system configuration diagram showing another example configuration of the promotion system according to the present invention;

FIG. 4 is a flow chart showing a flow of an operation by the point issuing unit shown in FIG. 1; and

FIG. 5 is a flow chart showing detailed processing of the data center shown in FIG. 1.

### DESCRIPTION OF THE PREFERRED EMBODIMENTS

Embodiments of the promotion system to which the present invention pertains will be described in detail with reference to the accompanying drawings.

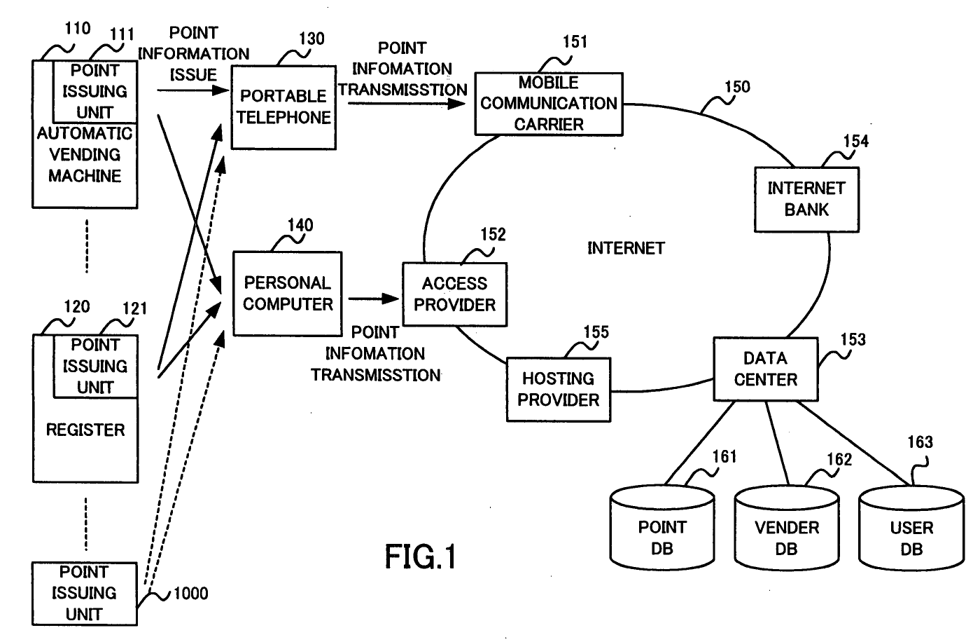

FIG. 1 is a system configuration diagram showing an example configuration of the promotion system according to the present invention.

In FIG. 1, this promotion system issues points for commodities soled by a plurality of automatic vending machines 110 disposed outdoors and indoors or cash registers 120 disposed in various types of stores and shops.

Specifically, this promotion system enables the sales promotion of commodities to be sold by the automatic vending machines 110 or the sales promotion of various kinds of commodities in stores and shops where the cash registers 120 are provided.

Every time a commodity is sold by the automatic vending machine 110, point issuing unit 111 mounted on the automatic vending machine 110 generates point information corresponding to the selling price, the sold quantity and the like of the sold commodity and indicates the point information on an unshown display section disposed on the point issuing unit 111.

Every time a sale is made by the cash register 120, point issuing unit 121 mounted on the cash register 120 also generates point information corresponding to the selling price, the sold quantity and the like of the sold commodity and indicates the point information on an unshown display section disposed on the point issuing unit 121.

And, every time a predetermined sale is made, independent point issuing unit 1000 also generates point information corresponding to the selling price, the sold quantity and the like and indicates the point information on an unshown display section disposed on the point issuing unit 1000.

The aforesaid point information contains the following:
1) a module code,
2) a secret code, and
3) a sub-code.

Here, the module code is used to identify the aforesaid point issuing units 111, 121 or the like, and this promotion system is configured to store and manage the states of the automatic vending machine 110, the cash register 120 and the like in accordance with the module code by vender database (vender DB) 162 of data center 153.

The secret code contains the following:
1) a point issue number,
2) a number of points, and
3) parity.

Here, the point issue number is a serial number issued every time points are issued by the point issuing units 111, 121 respectively and used to check double use and unauthorized use of the point information.

The number of points is a number of points which a user obtains at every purchase, and the parity is additional information used to check that the point information transmitted from the user is free from an error or tampering while being transmitted including encryption and decryption processing.

The secret code is generated by encrypting such information by a previously recorded cryptographic key.

The sub-code contains the following:
1) a commodity code,
2) date information,
3) price information,
4) an area code,
5) a distributor code, etc.

Here, the commodity code is information for identification of the commodity sold by the automatic vending machine 110 and the cash register 120. When the point issuing unit 111 is disposed in the automatic vending machine 110, it is possible to configure so that the commodity code is generated in correspondence with the number of a column in which the commodities are stored within the automatic vending machine, and added to the aforesaid point information.

It is also possible to configure so that the commodity code is generated on the basis of a serial number indicated on commodities or information of a bar code about the commodity indicated on the commodity and added to the point information.

The commodity code may be included in either the aforesaid module code or the secret code.

The date information is information about a date and time when the commodity is sold, and the price information is information about the selling price of the commodity. And, the area code is information related to places where the automatic vending machine 110 and the cash register 120 are disposed by which the commodities are sold.

And, the distributor code is information used when a plurality of promotion systems to be configured on the promotion system are desired to be managed and used separately to determine to which distributors the point information sent from the user belongs.

For example, when the products of Company A and promotion of the products of Company B are desired to be promoted separately on the same promotion system, the distributor code is used to determine which of Companies A and B the point information sent from the user belongs to.

The distributor code can also be used to identify a plurality of promotion systems performed by the same company. For example, when a certain beverage manufacturer desires to separately make sales promotion of refreshing beverages and sales promotion of beers on the same promotion system, the distributor code can be used to identify to which of the promotion system for the refreshing beverages and the promotion system for the beers the point information sent from the user belongs.

The user of the promotion system reads and records the point information indicated on the display sections of the point issuing units 111, 121, inputs the recorded point information to portable telephone 130 or personal computer 140 and sends it to the data center 153 together with ID (identification information) for identifying the user and a predetermined password.

An IR communication device may be built in the point issuing units 111, 121 to input the point information to the portable telephone 130 or the like by the IR communication device.

The point issuing units 111, 121 may be provided with means for printing to output the point information.

The point issuing unit 121 of the cash register 120 may be configured to print to output the point information generated by the point issuing unit 121 onto a receipt printed by and output from the cash register 120.

The data center 153 is provided with point database (point DB) 161 which is configured as a web server on the Internet 150 and stores and manages the points obtained by the user in correspondence with the user ID, the vender database (vender DB) 162 which stores and manages the states and the like of the automatic vending machine 110 and the cash register 120 according to the module code, and user database (user DB) 163 which stores and manages individual information of the users.

The point information is sent from the portable telephone 130 carried by the user to the data center 153 through the portable telephone 130, mobile transmission carrier 151 and the Internet 150.

The point information is sent from the personal computer 140 of the user to the data center 153 through the personal computer 140, user access provider 152 and the Internet 150.

The data center 153 receives the point information from the user's portable telephone 130 or the personal computer 140 and checks the user ID and password with reference to the user database 163.

Then, the module code is checked with reference to the vender database 162.

The secret code is decrypted, the parity, the point issue number and the number of points are checked, and the point database 161 is updated according to the checked results.

The data center 153 also conducts the following:
1) management of the users on the basis of registration and update of the user database 163,
2) management of points on the basis of the point database 161,
3) management of the point issuing unit on the basis of registration and update of the vender database 162,
4) management of various types of lotteries and winners on the basis of the points stored in the point database 161,
5) provision of marketing information to the administrator of the automatic vending machines 110 and the stores and shops or the like where the cash register 120 is disposed, and
6) sales information, commodities, changes, failures and the like of the automatic vending machines 110.

The Internet 150 has thereon Internet bank 154 which settles an account related to the aforesaid points for the data center 153, hosting provider 155 which serves instead of the data center 153 to deliver home pages in order to provide marketing information to the administrator of the automatic vending machines 110 and the stores and shops or the like where the cash register 120 is disposed, and the like.

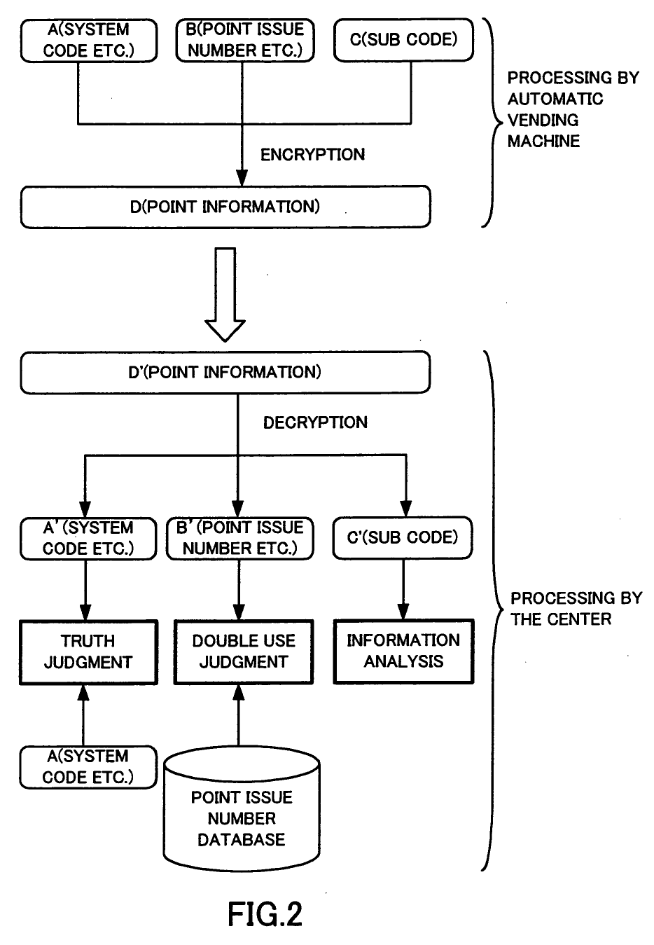

The point information generated by the point issuing unit 111 and the point issuing unit 121 is generated by the method as shown in FIG. 2 for example.

Specifically, the point issuing unit 111 and the point issuing unit 121 encrypt information (a system code etc.) A unique to the promotion system, information (a point issue number etc.) B unique to the issued point, and sub-code C containing various types of information to be used for management or the like of the promotion system according to a predetermined cryptographic key to generate point information D, and visualize and show it on the unshown point information display section as shown in FIG. 2.

The sub-code C is a code including information (distributor code) C1 unique to the distributor of the commodity, information (commodity code) C2 unique to the commodity, date information C3 (date code) related to the date and time when the commodity is sold, price information (price code) C4 related to the selling price of the sold commodity and information (area code) C5 related to the place where the automatic vending machine 110 or the cash register 120 having sold the commodity is disposed.

A purchaser sends the displayed point information D to the data center 153 by means of the portable telephone 130 or the personal computer 140.

The data center 153 having received point information D′ (if genuine, it is the same as the point information D) obtains information A′, information B′ and information C′ by a predetermined decryption key.

Then, the information A′ and the information (system code etc.) A unique to the promotion system previously stored in the data center 153 are compared to check whether the pertinent point information is genuine or not (truth or falsehood judgment).

Then, the information C1 is extracted from the information C′ to specify a distributor of a commodity corresponding to the point information.

Further, the information B′ is searched in a point issue number database of the data center 153 which manages the information B for each distributor to check whether it is unused or not (double use judgment).

Upon judging that the point information is true as a result of the above truth or falsehood judgment and double use judgment, the data center 153 extracts points contained in the information B′, analyzes the information C′ and obtains information about identification of the commodity corresponding to the point information, the date and time when the commodity is sold, the selling price of the commodity, and the place where the automatic vending machine 110 and the cash register 120 having sold the commodity are disposed.

And, the points extracted from the information B′ are selectively processed according to any piece of or a combination of the information obtained from the information C′.

Here, the processing of points is to add a predetermined point to the extracted points, e.g., when sales promotion of a given commodity is mainly performed for a predetermined period, the number of points corresponding to point information of the predetermined commodity sold in the predetermined period is doubled by the data center 153 and added to the number of points stored for management by the data center.

Besides, using the above various kinds of information obtained from the information C′, marketing information to be provided to the administrator of the automatic vending machine 110 and the stores and shops where the cash register 120 is disposed can also be generated.

For example,

1) a sale of each commodity, e.g., this commodity does not sell well but that commodity sells well, can be grasped by taking statistics of information C2 (commodity code);

2) a change of sales per time zone, such as a day unit, a week unit or the like, can be grasped by taking statistics of information C3 (date information);

3) good selling information or the like of commodities according to price ranges can be grasped by taking statistics of information C4 (price information);

4) good selling information or the like of commodities in each area can be grasped by taking statistics of information C5 (area code);

5) a sales situation of each distributor using the promotion system can be grasped by taking statistics of information C1 (distributor code); and

6) more detailed marketing information can be obtained by combining the above analyzing methods 1) to 5).

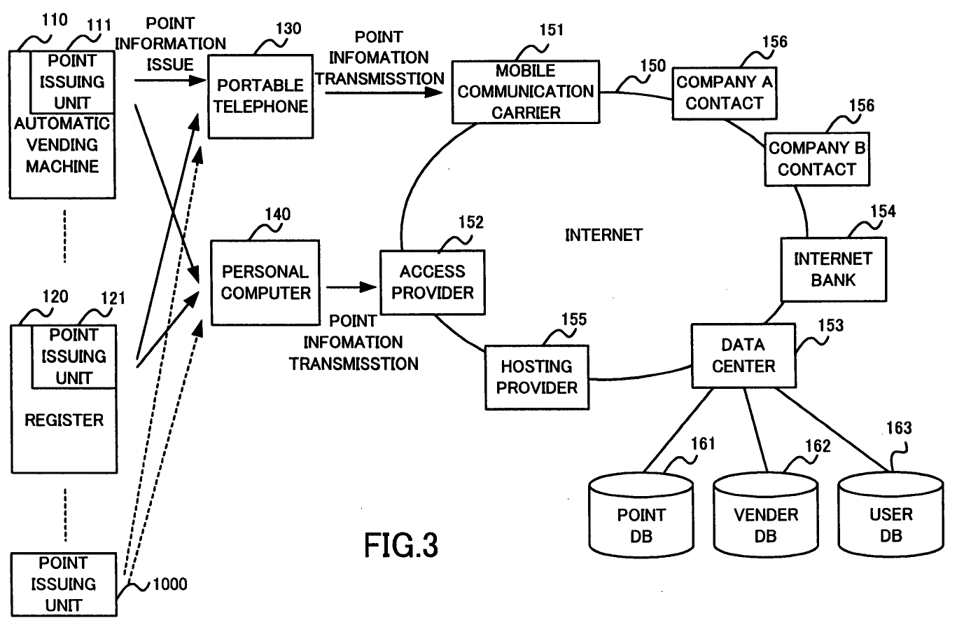

FIG. 3 is a system configuration diagram showing another example configuration of the promotion system to which the present invention pertains.

The promotion system shown in FIG. 3 adds the distributor code which was added to the point information by the point issuing units 111 and 121 at contact 156 for each distributor configured on the Internet 150 in the promotion system shown in FIG. 1.

In other words, the distributor code is not added to the point information issued by the point issuing units 111 and 121. The user sends the obtained point information to the contact 156 of the distributor of the purchased commodity, and the distributor contact 156 adds the distributor code to the point information received from the user and sends it to the data center 153.

The other structure of the promotion system shown in FIG. 3 is the same as the one shown in FIG. 1.

Then, the method for generation of point information by the point issuing unit and processing by the data center 153 will be described.

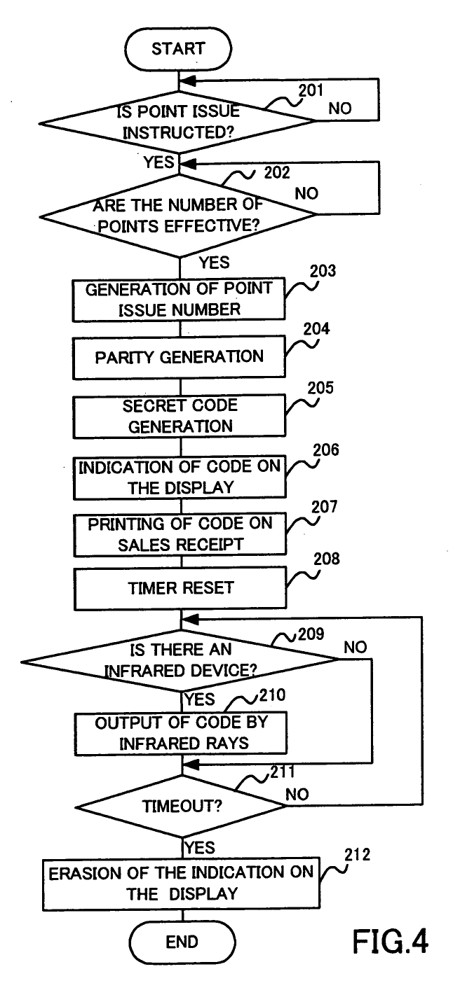

FIG. 4 is a flow chart showing detailed processing of the point issuing unit (point issuing unit 111 or 121) shown in FIG. 1.

In FIG. 4, the point issuing unit checks whether the automatic vending machine 110 or the cash register 120 instructs to issue points (step 201). Here, when it is judged that there is no instruction to issue points, the processing returns back to step 201, and the point issuing unit waits for an instruction to issue points.

When the automatic vending machine 110 or the cash register 120 instructs to issue points in step 201 (YES in step 201), it is checked whether the number of points whose issue is instructed is effective or not (step 202). Here, when it is judged to be ineffective (NO in step 202), the processing returns back to step 202, but when it is judged to be effective (YES in step 202), a point issue number is generated (step 203). The point issue number is generated with 1 added to the previously issued point issue number.

Then, parity is generated (step 204). For example, to generate parity, information about the point issue number generated in the step 203 and the number of points which is judged to be effective in the step 202 are delimited with each n bit and added, and the obtained value is divided by m to obtain the remainder.

Further, the commodity code of the commodity sold by the automatic vending machine 110 or the cash register 120 is obtained.

The commodity code may be obtained when the commodity is sold by storing the commodity codes of the respective commodities in association with the column numbers in the columns for storing the commodities within the automatic vending machine 110, or a bar-code reader may be provided to the automatic vending machine 110 and the cash register 120, so that the customer or the seller makes the bar-code reader read a bar code indicated on the commodity to obtain the commodity code according to information of the read bar code. And, the commodity code may be obtained according to the serial number indicated on the commodity.

And, a secret code is generated (step 205). This secret code is generated by encrypting the aforesaid point issue number, the number of points and the parity by a previously stored cryptographic key.

The secret code generated as described above is shown on a display of the point issuing unit as point information together with a module code of the point issuing unit (step 206) and also printed on the receipt (step 207).

Then, a timer for limiting the indication of the point information on the display is reset (step 208), and it is checked whether the point issuing unit has an infrared device for outputting the point information (step 209).

When it is judged that it has an infrared device (YES in step 209), the aforesaid point information (code) is output by infrared rays (step 210).

Then, it is checked whether the timer has expired (step 211), and if not (NO in step 211), the processing returns back to the step 209, but if judged expired (YES in step 211), the indication on the display is erased (step 212), and the processing is terminated.

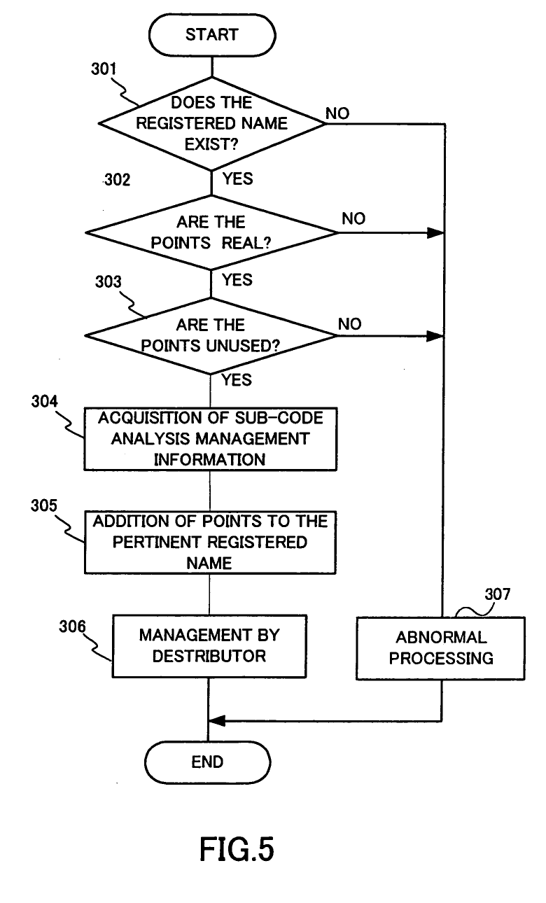

FIG. 5 is a flow chart showing a flow of the operation of the data center 153 which has received the aforesaid point information.

In FIG. 5, when the data center 153 obtains point information, it is judged whether there is a registered name (one registered arbitrarily in the name of the point information sending person) which is received together with the point information (step 301), and when there is a registered name (YES in step 301), it is checked whether the point information is true or not (step 302).

And, when it is found that the point information is true (YES in step 302), it is checked whether the pertinent points are not used (step 303).

When it is found that the points are not used, the sub-code to be added to the point information is analyzed (step 304), the number of points based on the received point information is added to the number of points for the registered name stored (step 305), and the number of points is managed for each distributor according to the distributor code (step 306) to terminate the processing.

Meanwhile, when there is not a registered name (NO in step 301), points are forgery (NO in step 302) or points are used a plurality of times (NO in step 303), it is determined as abnormal processing, and the processing is terminated without adding the number of points (step 307).

The abnormal processing is not limited to no addition of points but also can accumulate the number of abnormal processing times in the pertinent cash registered name and, when the abnormal processing occurs not less than a predetermined number of times, it can delete the pertinent registration. And, when there is not a registered name, new registration may be accepted, so that the processing from the step 302 can be performed.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A promotion method comprising the steps of:
issuing, from a point issuing unit to a user, point information related to predetermined points when a commodity is sold by an automatic vending machine;
adding system information about a distributor of the commodity to the point information issued fro the point issuing unit in the point information issuing step;
sending the point information with the system information added in the system information adding step to a center unit together with identification information of the user by operations of a portable terminal carried by the user;
receiving, at the center unit, the point information and the identification information of the user sent in the point information sending step;
separately managing, by the center unit, services to be provided to the user according to the system information added to the point information received in the receiving step in association with the distributor of the commodity; and
providing a predetermined service to the user by referring to the services managed in the managing step.

13. The promotion method according to claim 12, wherein the system information adding step comprises the step of adding the system information to the point information by the point issuing unit.

14. The promotion method according to claim 12, wherein:
the point information is sent to the center unit through a system terminal disposed at the distributor of the commodity, and
the system information adding step comprises the step of adding the system information to the point information by the system terminal.

15. The promotion method according to claim 12, wherein:
the point information includes at least one of a commodity code unique to the commodity, date information when the commodity is sold, price information of the commodity and an area code related to a place where a machine having sole the commodity is installed; and
the center unit collectively changes the services to be provided to the user according to at least one of a kind commodity, a date when the commodity is sold, a price of the commodity and a place where the machine having sold the commodity is installed.

16. The promotion method according to claim 15, wherein:
the commodity code is added to the point information in correspondence with the number of a column of the automatic vending machine in which the commodity is stored.

17. The promotion method according to claim 15, wherein the commodity code is added to the point information in correspondence with an identifier on the commodity.

18. The promotion method according to claim 15, wherein the commodity code is added to the point information according to information of a bar code related to and indicated on the commodity.

19. A promotion system comprising:
a point issuing unit for issuing to a user, when a commodity is sold by an automatic vending machine, point information related to predetermined points and added with system information about a distributor of the commodity;
sending means for sending, from the point issuing unit to a center unit, the point information added with the system information together with identification information of the user by operations of a portable terminal carried by the user;
receiving means, disposed in the center unit, for receiving the point information and the identification information of the user sent from the sending means;
managing means, disposed in the center unit, for separately managing services to be provided to the user according to the system information added to the point information received at the receiving means in association with the distributor of the commodity; and
service providing means for providing a predetermined service to the user by referring to the services managed by the managing means.

20. The promotion system according to claim 19, wherein:
the point information includes at least one of a commodity code unique to the commodity, date information when the commodity is sold, price information of the commodity and an area code related to a place where a machine having sold the commodity is installed; and
the center unit comprises changing means for collectively changing the services to be provided to the user according to at least one of a kind commodity, a date when the commodity is sold, a price of the commodity and a place where the machine having sold the commodity is installed.

21. A promotion system comprising:
a point issuing unit for issuing, to a user, point information related to predetermined points when a commodity is sold by an automatic vending machine;
first sending means for sending the point information issued from the point issuing unit to a system terminal provided in correspondence with a distributor of the commodity together with identification information of the user by operations of a portable terminal carried by the user;
second sending means, provided in association with the distributor of the commodity, for sending the point information sent from the first sending means and added with system information about the distributor of the commodity to a center unit together with the identification information of the user;
receiving means, disposed in the center unit, for receiving the point information and the identification information of the user sent from the second sending means;
managing means, disposed in the center unit, for separately managing services to be provided to the user according to the system information added to the point information received by the receiving means in association with the distributor of the commodity; and
service providing means for providing a predetermined service to the user by referring to the services managed by the managing means.

22. The promotion system according to claim 21, wherein:
the point information includes at least one of a commodity code unique to the commodity, date information when the commodity is sold, price information of the commodity and an area code related to a place where a machine having sold the commodity is installed; and
the center unit comprises changing means for collectively changing the services to be provided to the user according to at least one of a kind commodity, a date when the commodity is sold, a price of the commodity and a place where the machine having sold the commodity is installed.
